(19) United States
(12) Patent Application Publication
(10) Pub. No.: US 2012/0098773 A1
(43) Pub. Date: Apr. 26, 2012

(54) MOBILE ELECTRONIC DEVICE

(75) Inventors: Hiroki KOBAYASHI, Daito-shi (JP); Shinpei Ozako, Daito-shi (JP)

(73) Assignee: Kyocera Corporation, Kyoto (JP)

(21) Appl. No.: 13/278,133

(22) Filed: Oct. 20, 2011

(30) Foreign Application Priority Data
Oct. 21, 2010 (JP) 2010-236102

(51) Int. Cl. G06F 3/041

(52) U.S. Cl. 345/173

(57) ABSTRACT

A mobile electronic device and method is disclosed. A first touch input on a first display screen is detected, and a second touch input on a second display screen is detected, if a first time threshold is not reached. The first display screen and the second display screen are combined to operate as a single display screen, if a second time threshold is reached after the first touch input.

### CROSS-REFERENCE TO RELATED APPLICATION

The present application claims priority under 35 U.S.C. §119 to Japanese Patent Application No. 2010-236102, filed on Dec. 21, 2010, entitled “MOBILE TERMINAL DEVICE”. The content of which is incorporated by reference herein in its entirety.

### FIELD

Embodiments of the present disclosure relate generally to mobile electronic devices, and more particularly relate to a mobile electronic device comprising more than one display screen thereon.

### BACKGROUND

Electronic devices comprising a plurality of touch panels are well-known. With electronic devices comprising a plurality of touch panels, functions can be set for each touch panel. Users can execute functions set to the touch panel which users touch by touching the touch panel. However, with such electronic devices, users may be limited to executing functions that are set to the individual touch panel alone.

### SUMMARY

A mobile electronic device and method is disclosed. A first touch input on a first display screen is detected, and a second touch input on a second display screen is detected, if a first time threshold is not reached. The first display screen and the second display screen are combined to operate as a single display screen, if a second time threshold is reached after the first touch input.

In an embodiment, a mobile electronic device comprises a first display module, a second display module, a first detector, a second detector, and a control module. The first detector is located on the first display module operable to detect a first input, and the second detector is located on the second display module operable to detect a second input. The control module is operable to control both a first display screen on the first display module and a second display screen on the second display module when the first detector detects the first input and the second detector detects the second input.

In another embodiment, a method for operating a mobile electronic device comprises detecting a first touch input on a first display screen, and detecting a second touch input on a second display screen, if a first time threshold is not reached. The method further comprises combining the first display screen and the second display screen to operate as a single display screen, if a second time threshold is reached after the first touch input.

In a further embodiment, a computer readable storage medium comprises computer-executable instructions for performing a method for operating a portable electronic device. The method executed by the computer-executable instructions comprises detecting a first touch input on a first display screen, and detecting a second touch input on a second display screen, if a first time threshold is not reached. The method executed by the computer-executable instructions further comprises combining the first display screen and the second display screen to operate as a single display screen, if a second time threshold is reached after the first touch input.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1 is an illustration of an exploded perspective view showing a configuration overview of a mobile electronic device according to an embodiment of the disclosure.

FIGS. 2(a) to 2(d) is an illustration of an operation for switching a mobile electronic device from a first state to the second state according to an embodiment of the disclosure.

FIG. 3 is an illustration of a functional block diagram of a mobile electronic device according to an embodiment of the disclosure.

FIG. 4 is an illustration of a flowchart showing a process for controlling display screens of a mobile electronic device according to an embodiment of the disclosure.

FIGS. 5(a) to 5(b) is an illustration of display screens displayed on each display surface of a mobile electronic device according to an embodiment of the disclosure.

FIGS. 6(a) to 6(b) is an illustration of display screens displayed on each display surface of a mobile electronic device according to an embodiment of the disclosure.

FIG. 7 is an illustration of display screens displayed on each display surface of a mobile electronic device according to an embodiment of the disclosure.

FIG. 8 is an illustration of a flowchart showing a process for controlling display screens of a mobile electronic device according to an embodiment of the disclosure.

FIG. 9 is an illustration of display screens displayed on each display surface of a mobile electronic device according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, GPS's or navigation systems, pedometers, health equipments, display monitors, and the like. As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

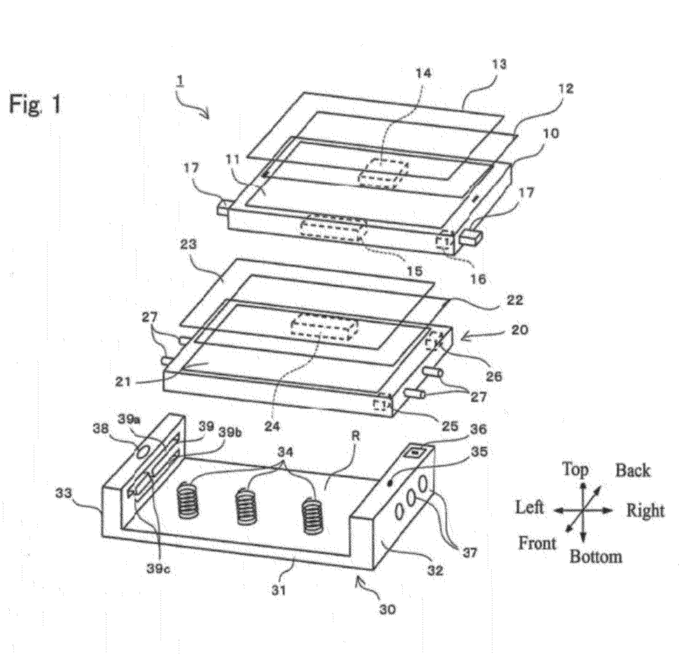

FIG. 1 is an exploded perspective view showing a configuration overview of a mobile phone 1. The mobile phone 1 comprises a first cabinet 10, a second cabinet 20, and a supporter 30 that supports the first cabinet 10 and the second cabinet 20.

A first touch panel comprises a first display 11, a first touch sensor 12, and a first transparent cover 13. The first transparent cover 13 is disposed on a front surface of the first touch sensor 12. The first transparent cover 13 covers the first touch sensor 12 and appears in front of the first cabinet 10.

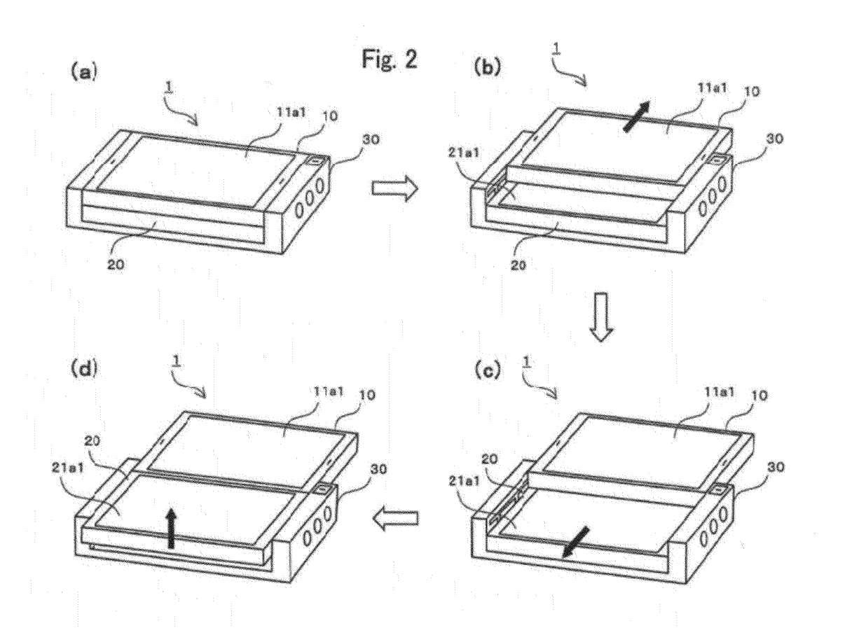

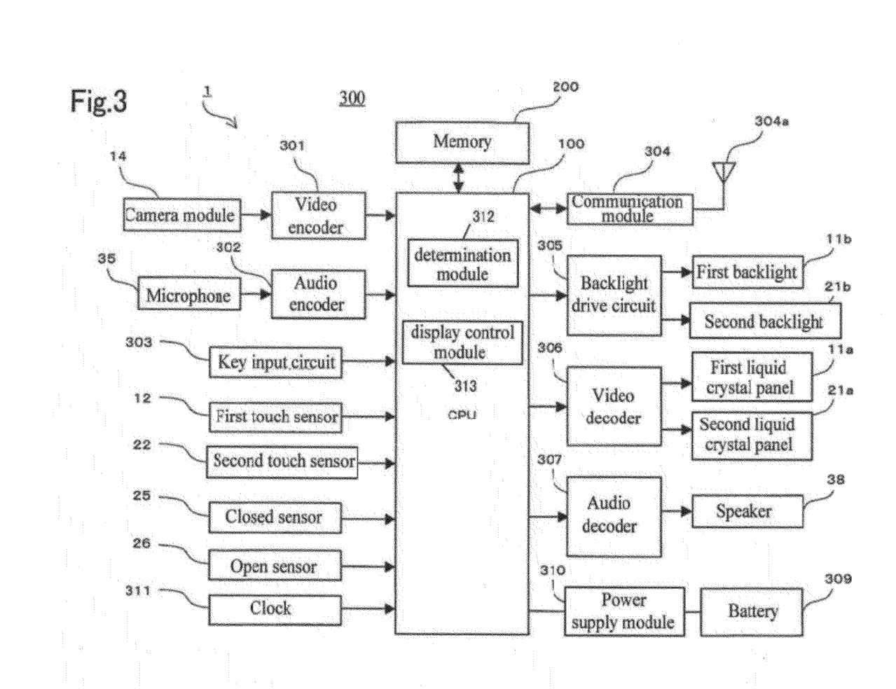

The first display 11 comprises a first liquid crystal panel 11 a and a first backlight 11b shown in FIG. 3. The first display 11 can display a first screen on the first liquid crystal panel 11a. An area in which the first screen is displayed may also be referred to as a first display surface 11a1 in FIG. 2. In one embodiment, as shown in FIG. 2, the area of the first liquid crystal panel 11a exposed from the first cabinet 10 is the first display surface 11a1. The first screen displayed on the first liquid crystal panel 11a may also be referred to as a first image.

The first touch sensor 12 is a transparent rectangular sheet and is provided over the first display surface 11a1 of the first display 11. The first touch sensor 12 comprises a first transparent electrode and a second transparent electrode disposed in a matrix shape. By detecting changes in capacitance between these transparent electrodes, the first touch sensor 12 detects the position above the first display surface 11a1 touched by a user and it can output the position signals corresponding to that position to a CPU 100 (FIG. 3). The first touch sensor 12 is a first detection module (first detector) that detects inputs by the user, with respect to the first screen displayed on the first display surface 11a1 by the first display 11. The user touching the first display surface 11 al refers to, for example, the user pressing and stroking the first display surface 11a1 and drawing shapes and characters with a touching object such as a finger or a pen. Touching the first display surface 11a1 refers to touching the area in which the first screen of the first display surface 11a1 is reflected, on the first transparent cover 13, which is described subsequently.

A camera module 14 is housed in a middle position and slightly toward a rear of the first cabinet 10. A lens window for capturing a subject image to the camera module 14 may be provided on the first cabinet 10.

A magnet 15 is provided in a middle position in a vicinity of the front surface, inside the first cabinet 10. A magnet 16 is provided at a front right corner, inside the first cabinet 10.

A protruding part 17 is provided on a right and left sides of the first cabinet 10.

A shape and size of the second cabinet 20 may be nearly the same as those of the first cabinet 10. The second cabinet 20 comprises a second touch panel, a magnet 24, a closed sensor 25, an open sensor 26, and shanks 27. The second touch panel comprises a second display 21, a second touch sensor 22, and a second transparent cover 23. The second transparent cover 23 covers the second touch sensor 22 and appears in front of the second cabinet 20.

The second display 21 comprises a second liquid crystal panel 21a and a second backlight 21b shown in FIG. 3. The second display 21 can display a second screen on the second liquid crystal panel 21a. An area in which the second screen is displayed may also be referred to as a second display surface 21a1. In one embodiment, as shown in FIG. 2, the area of the second liquid crystal panel 21 a exposed from the second cabinet 20 comprises the second display surface 21a1. The first display 11 and the second display 21 may be constituted from other display elements such as an organic EL. The second screen displayed on the second liquid crystal panel may also be referred to as a second image.

The second touch sensor 22 is disposed over the second display 21. The transparent cover 23 is disposed on the front surface of the second touch sensor 22. The configuration of the second touch sensor 22 is similar to the configuration of the first touch sensor 12. The second touch sensor 22 is a second detection module (second detector) that detects inputs by the user, with respect to the second screen displayed on the second screen 21a1 by the second display 21. The user touching the second display surface 21a1 refers to, for example, the user pressing and stroking the second display surface 21a1 and drawing shapes and characters with a touching object such as a finger or a pen. The user touching the second display surface 21a1 refers to the user touching the area in which the second screen of the second display surface 21a1 is reflected, inside the second transparent cover 23, which is described subsequently.

The magnet 24 is provided in a middle position in the vicinity of the rear surface, inside the second cabinet 20. The magnet 24 and the magnet 15 are constituted so as to attract each other in a second state. The second state is a state in which, as shown in FIG. 2(d), both the first cabinet 10 and the second cabinet 20 are exposed. If the magnetic force of either one of the magnet 24 or the magnet 15 is sufficiently large, the other magnet may be replaced with a magnetic body.

The closed sensor 25 is provided at the front right corner, inside the second cabinet 20. The open sensor 26 is provided at the back right corner, inside the second cabinet 20. The closed sensor 25 and the open sensor 26 comprise, for example, a Hall IC. The closed sensor 25 and the open sensor 26 react to the magnetic force of the magnet 16 and can output detection signals to the CPU 100, which is described subsequently. As shown in FIG. 2(a), when the state in which the first cabinet 10 and the second cabinet 20 overlap is reached, the magnet 16 of the first cabinet 10 approaches the closed sensor 25, resulting in ON signals being output from the closed sensor 25. As shown in FIG. 2(d), when the state in which the first cabinet 10 and the second cabinet 20 are disposed side by side is reached, the magnet 16 of the first cabinet 10 approaches the open sensor 26, resulting in ON signals being output from the open sensor 26.

The supporter 30 comprises a base plate part 31, a right holding part 32 formed on the right edge of the base plate part 31; and a left holding part 33 formed on the left edge of the base plate part 31. A housing area R is the area formed by the base plate part 31, the right holding part 32, and the left holding part 33.

On the base plate part 31, three coil springs 34 are horizontally disposed side by side. In the state in which the second cabinet 20 is attached to the supporter 30, the three coil springs 34 come in contact with the bottom surface of the second cabinet 20. The three coil springs 34 provide force to push upwards with respect to the second cabinet 20.

A microphone 35 and a power key 36 are provided on the upper surface of the right holding part 32. A plurality of operation keys 37 are provided on the lateral surface of the right holding part 32. The user can execute predefined functions, such as silent mode, by operating the plurality of operation keys 37.

A speaker 38 is provided on the top surface of the left holding part 33. The user can make a call by holding the mobile phone 1 such that the left holding part 33 side is brought within the vicinity of the ear and the right holding part 32 side within the vicinity of the mouth. When the user confirms the address book while making a call, the user may make a call so as not to place the left holding part 33 to the ear, such as a hands-free state.

A guide groove 39 is formed on the inner side of the right holding part 32 and the left holding part 33. The guide groove 39 comprises an upper groove 39a, a lower groove 39b, and two vertical grooves 39c. The upper groove 39a and the lower groove 39b extend longitudinally. The vertical grooves 39c extend so as to join the upper groove 39a and the lower groove 39b.

As the two shanks 27 are inserted into the lower groove 39b of the guide groove 39, the second cabinet 20 is housed inside the housing area R of the supporter 30. As the protruding part 17 is inserted into the upper groove 39a of the guide groove 39, the first cabinet 10 is disposed above the second cabinet 20, and the first cabinet 10 is housed inside the housing area R of the supporter 30.

In the housing area R, the first cabinet 10 and the second cabinet 20 are housed in a state in which they overlap each other vertically. In this state, the first cabinet 10 is guided by the upper groove 39a such that it can move back and forth. The second cabinet 20 is guided by the lower groove 39b such that it can move back and forth. When the second cabinet 20 moves forward and the shanks 27 reach the vertical grooves 39c, the second cabinet 20 is guided by the vertical grooves 39c such that it can move up and down.

FIG. 2(a) to FIG. 2(d) are illustrations of operations for switching a mobile electronic device from the first state to the second state according to an embodiment of the disclosure.

FIG. 2(a) indicates that the mobile phone 1 is in the first state. The first state refers to a state in which the first cabinet 10 is disposed above the second cabinet 20. In the first state, the first display surface 11a1 is exposed, and the second display surface 21a1 is hidden by the first cabinet 10.

As shown in FIG. 2(b), the user moves the first cabinet 10 backwards as shown by the arrow. Next, as shown in FIG. 2(c), the user pulls out the second cabinet 20 forward. When the second cabinet 20 moves to the position at which the second cabinet 20 is disposed in front of the first cabinet 10 by the pulling operation, the second cabinet 20 no longer overlaps the first cabinet 10 completely. At this time, the shanks 27 shown in FIG. 1 reach the vertical grooves 39c and, as a result, the second cabinet 20 is pushed upwards by the coil springs 34. Because the magnet 15 and the magnet 24 attract each other, upward force is further applied to the second cabinet 20.

FIG. 2(d) indicates that the mobile phone 1 is in the second state. In the second state, the second cabinet 20 is disposed so as to come in close contact with the first cabinet 10 side by side, establishing a single flat surface. The mobile phone 1 can be switched from the first state to the second state. In the second state, the first cabinet 10 and the second cabinet 20 are spread out and both the first display surface 11a1 and the second display surface 21a1 are exposed.

FIG. 3 is an illustration of a functional block diagram of the mobile phone 1 (system 300) according to an embodiment of the disclosure. Besides the respective components described above, the system 300 comprises a CPU 100, a memory 200, a video encoder 301, an audio encoder 302, a key input circuit 303, a communication module 304, a backlight drive circuit 305, a video decoder 306, an audio encoder 307, a battery 309, a power supply module 310, and a clock 311.

The camera module 14 comprises an image sensor such as a CCD. The camera module 14 digitalizes the imaging signals output from the image sensor. The camera module 14 performs various corrections such as a gamma correction on the digitalized imaging signals and outputs them to the video encoder 301. The video encoder 301 performs encoding processing on the imaging signals from the camera module 14 and outputs them to the CPU 100.

The microphone 35 converts the collected sound into sound signals and outputs them to the audio encoder 302. The audio encoder 302 converts the analog sound signals from the microphone 35 into digital sound signals while simultaneously performing encoding processing on the digital sound signals and outputs them to the CPU 100.

When the power key 36 and/or the respective operation keys 37 are operated, the key input circuit 303 outputs the signals corresponding to the respective keys to the CPU 100.

The communication module 304 transmits information from the CPU 100 to the base station through an antenna 304a. The communication module 304 outputs the signals received through the antenna 304a to the CPU 100.

The backlight drive circuit 305 applies the voltage corresponding to the control signals from the control module 100 (CPU 100) to the first backlight 11 b and the second backlight 21b. The first backlight 11b is lit up as a result of the voltage by the backlight drive circuit 305 and illuminates the first liquid crystal panel 11a. The second backlight 21b is lit up as a result of the voltage by the backlight drive circuit 305 and illuminates the second liquid crystal panel 21a.

The video decoder 306 converts video signals from the CPU 100 into video signals that can be displayed on the first liquid crystal panel 11a and the second liquid crystal panel 21a, and outputs these signals to the liquid crystal panels 11a, 21a. The first liquid crystal panel 11a can display the first screen corresponding to the video signals on the first display surface 11a1. The second liquid crystal panel 21a can display the second screen corresponding to the video signals on the second display surface 21a1 .

The audio encoder 307 performs decoding processing on the sound signals from the CPU 100 and the sound signals of various notification sounds such as ringtones and alarm sounds, converts them into analog sound signals, and outputs them to the speaker 38. The speaker 38 plays the sound signals from the audio encoder 307, ringtones, etc. The sound signal may comprise voice signal.

The battery 309 is used for supplying electric power to the CPU 100 and/or each part other than the CPU 100. The battery 309 comprises a secondary battery. The battery 309 is connected to the power supply module 310.

The power supply module 310 converts the voltage of the battery 309 into the necessary voltage size for each part and supplies it to each part. The power supply module 310 supplies the electric power supplied through external power source and charges the battery 309.

The clock 311 measures time and outputs the signals corresponding to the measured time to the CPU 100.

The memory 200 may be any suitable data storage area with suitable amount of memory that is formatted to support the operation of the system 300. Memory 200 is configured to store, maintain, and provide data as needed to support the functionality of the system 300 in the manner described below. In practical embodiments, the memory 200 may comprise, for example but without limitation, a non-volatile storage device (non-volatile semiconductor memory, hard disk device, optical disk device, and the like), a random access storage device (for example, SRAM, DRAM), or any other form of storage medium known in the art.

The memory 200 may be coupled to the control module 100 and configured to store, for example but without limitation, the input parameter values and the output parameter values corresponding to the display control of the system 300. A control program executed in the control module 100 (CPU 100) is stored in the memory 200. The memory 200 can store image data taken with the camera module 14. The memory 200 can also store the image data, text data, sound data, etc., imported externally through the communication module 304.

A first processing procedure, a second processing procedure, and a third processing procedure are stored in the memory 200. The first processing procedure refers to a procedure performed when the CPU 100 determines that only the first display surface 11a1 has been touched. The second processing procedure refers to a procedure performed when the CPU 100 determines that only the second display surface 21a1 has been touched. The third processing procedure refers to a procedure performed when the CPU 100 determines that the first display surface 11a1 and the second display surface 21a1 are simultaneously touched. The third processing procedure further comprises a procedure performed corresponding to the action performed by the user after the first display surface 11a1 and the second display surface 21a1 are touched simultaneously.

Based on the operation input signals from the key input circuit 303 and the respective touch sensors, the CPU 100 causes the camera module 14, the microphone 35, the communication module 304, the liquid crystal panels 11a, 21a, the speaker 38, etc., to operate according to the control program. Accordingly, the CPU 100 executes various applications such as call features and e-mail functions.

The CPU 100 comprises a determination part 312. Based on the detection signals from the first touch sensor 12 and the second touch sensor 22, the determination part 312 can determine which processing to execute among the three processing procedures stored in the memory 200.

The CPU 100 comprises a display control module 313. The display control module 313 can output the control signals to the video decoder 306 and the backlight drive circuit 305. According to the processing procedure that determines that the determination module 312 matches, the display control module 313 displays images on the respective display surfaces, by controlling the turning ON or OFF of the respective liquid crystal panels 11a, 21a and the respective backlights 11b, 21b. The images are constituted from information such as still images, videos, characters, and symbols. The display control module 313 can control the contrast, brightness, image size, transparency of the screen, etc., for cases in which the images are displayed on the first display surface 11a1 and the second display surface 21a1.

The CPU 100 can read out the first processing procedure to the third processing procedure from the memory 200. After receiving input signals from the respective touch sensors, the CPU 100 executes the first processing procedure to the third processing procedure, according to the input signals.

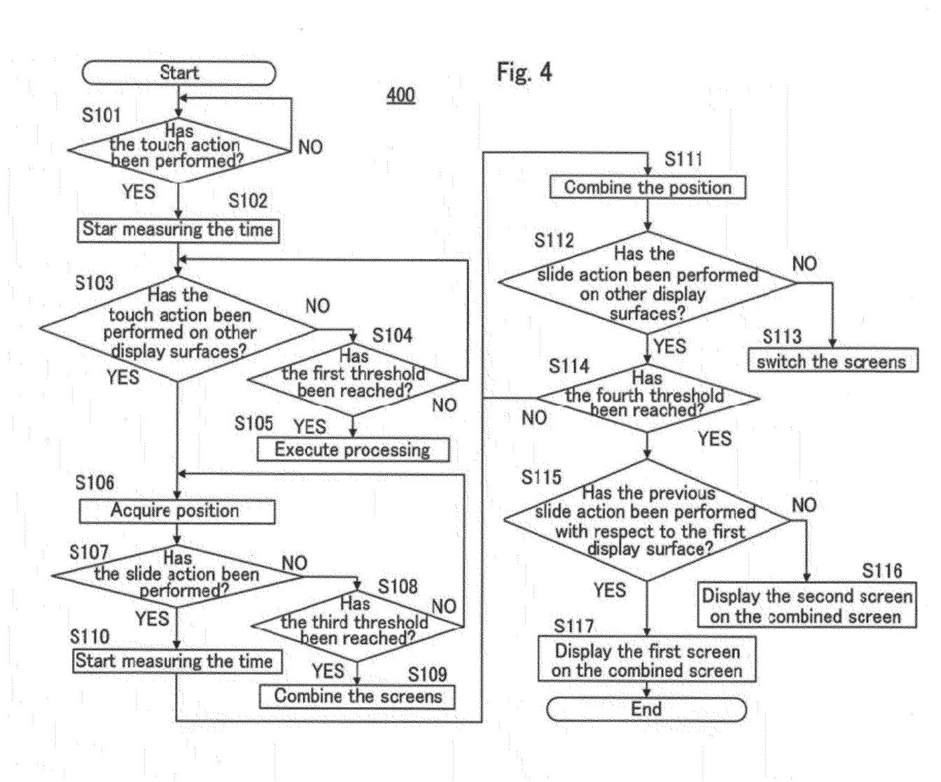

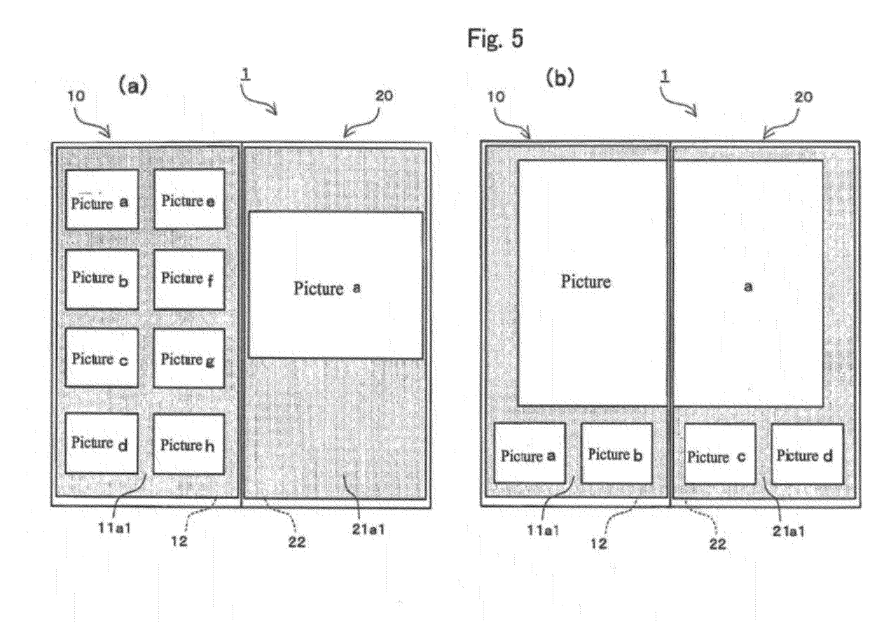

FIG. 4 is an illustration of a flowchart showing a process 400 for controlling the images to be displayed on the first display surface 11a1 and the second display surface 21a1 according to an embodiment of the disclosure. FIGS. 5-7 are illustrations of display screens displayed on each display surface of the mobile phone 1 according to an embodiment of the disclosure. FIG. 5 to FIG. 7 indicate the screens displayed on the first display surface 11a1 and the second display surface 21a1.

The various tasks performed in connection with the process 400 may be performed by software, hardware, firmware, a computer-readable medium having computer executable instructions for performing the process method, or any combination thereof. The process 400 may be recorded in a computer-readable medium such as a semiconductor memory, a magnetic disk, an optical disk, and the like, and can be accessed and executed, for example, by a computer CPU such as the control module 100 in which the computer-readable medium is stored.

It should be appreciated that process 400 may include any number of additional or alternative tasks, the tasks shown in FIG. 4 need not be performed in the illustrated order, and process 400 may be incorporated into a more comprehensive procedure or process having additional functionality not described in detail here

In practical embodiments, portions of the process 400 may be performed by different elements of the systems 300 such as: the CPU 100, the memory 200, the video encoder 301, the audio encoder 302, the key input circuit 303, the communication module 304, the backlight drive circuit 305, the video decoder 306, the audio encoder 307, the battery 309, the power supply module 310, the clock 311, the first display 11, the first touch sensor 12, the second display 21, the second touch sensor 22, etc. Process 400 may have functions, material, and structures that are similar to the embodiments shown in FIGS. 1-3. Therefore common features, functions, and elements may not be redundantly described here.

By performing a slide action with respect to both the first display surface 11a1 and the second display surface 21a1 or either one of the display surfaces, the user can change the display method of the data stored previously in the memory 200. The “slide action” refers to the action in which the user moves their finger in the state in which the finger is brought in contact with both the first display surface 11a1 and the second display surface 21a1 or that of either one of the display surfaces. The user may also use, for example but without limitation, a part of her/his body other than the fingers, pens, or other input means in contact with the display surface.

When the power key 36 is pressed by the user and the electric power is supplied from the battery 309 to the CPU 100, the control program that controls the screens displayed on the respective display surfaces 11a1, 21a1 starts up.

The CPU 100 can display a screen showing a predefined operation menu on the first display surface 11a1. As the user operates with respect to the screen of the operation menu, the CPU 100 starts a first program that displays a list of pictures and a second program that displays one picture. As shown in FIG. 5(a), the CPU 100 displays the first screen, which is output from the first program, on the first display surface 11a1, and displays the second screen, which is output from the second program, on the second display surface 21a1. The first screen comprises reduced images of the plurality of pictures. The second screen comprises raw images of one picture. The second screen may comprise at least one image larger in size than the compressed images displayed on the first screen.

The CPU 100 detects whether the touch action is performed by the user with respect to both the first display surface 11a1 and the second display surface 21a1 or either one of the display surfaces (task S101). When the user comes in contact with the first display surface 11a1, the CPU 100 receives the position signals from the first touch sensor 12 and detects that the touch action has been performed (task S101: YES). The CPU 100 obtains the touch position from the position signals and stores it in the memory 200. After receiving the signals from the clock 311, the CPU 100 starts measuring the elapsed time since the touch action was detected (task S102). When the CPU 100 stores the position signals from the touch sensor in the memory 200, it may add information that identifies the touch sensor to the position signals. The CPU 100 can identify whether or not the positional information stored in the memory 200 is the position signals output from one of the touch sensors. The “touch action” refers to the action in which the user brings the finger in contact with the display surface. As mentioned above, the user may use, for example but without limitation, a part of her/his body other than the fingers, pens, or other input means in contact with the display surface.

Next, in order to determine whether or not the user performed the touch action with respect to the first display surface 11a1 alone, the CPU 100 determines whether or not the touch action has been performed by the user with respect to the second display surface 21a1 (task S103). If no position signals are received from the second touch sensor 22, the CPU 100 determines that no touch action has been performed on the second display surface 21a1 (task S103: NO).

However, it may be difficult for the user to perform the touch action on the first display surface 11a1 and the second display surface 21a1 simultaneously. Therefore, if the touch action is performed with respect to the second display surface 21a1, while the elapsed time is within the first threshold since the touch action with respect to the first display surface 11a1, the CPU 100 may determine that the touch action has been performed simultaneously with respect to the two display surfaces. The first threshold may be set appropriately. However, if the first threshold is too short, the user needs to match the timing to touch the two display surfaces simultaneously in a highly accurate manner, which may result in operation difficulty.

For cases in which the first threshold is too long, even if the user intends to touch the two display surfaces individually, these touch actions may be mistakenly considered to have been performed simultaneously. Therefore, the first threshold is set by taking into consideration operability and the possibility of misdetection. The “simultaneous touch action” refers to the action in which the user brings the finger in contact with the two display surfaces simultaneously.

The CPU 100 determines whether or not the elapsed time since the touch action to the first display surface 11a1 reached the first threshold (task S104). While the elapsed time has not reached the first threshold (task S104: NO), the CPU 100 determines whether or not the touch action has been performed on the second display surface 21a1 (task S103). In the absence of the touch action on the second display surface 21a1, if time progresses, the CPU 100 determines that the elapsed time has reached the first threshold (task S104:YES). Since the second display surface 21a1 is not touched simultaneously with the first display surface 11a1, the CPU 100 determines that only the first display surface 11a1 has been touched.

At task S101 and task S102, if the second touch sensor 22 detects the touch action on the second display surface 21a1 , the CPU 100 may measure the elapsed time since the touch action. At task S103 and task S104, until the elapsed time since the touch action with respect to the second display surface 21a1 exceeds the first threshold, the CPU 100 may determine whether or not the touch action on the first display surface 11a1 is detected. If the touch action with respect to the first display surface 11a1 is not detected until the elapsed time since the touch action with respect to the second display surface 21a1 exceeds the first threshold, the CPU 100 may determine that only the second display surface 21a1 is touched.

For cases in which only the first display surface 11a1 is touched, based on the position signals from the first touch sensor 12, the CPU 100 detects the position, which is input with respect to the first display surface 11a1. The CPU 100 specifies processing corresponding to the position input. The CPU 100 executes specified processing (task S105). For example, for cases in which only the first display surface 11 al is touched, the first processing procedure refers to detecting the position input with respect to the first display surface 11a1, specifying processing corresponding to the position input, and executing specified processing. If processing corresponding to the position input is executed, the CPU 100 may display a fourth screen, which is different from the first screen, on the first display surface 11a1.

At task S105, for cases in which only the second display surface 21a1 is touched, based on the position signals from the second touch sensor 22, the CPU 100 detects the position input with respect to the second display surface 21a1 . The CPU 100 executes specified processing. For example, for cases in which only the second display surface 21a1 is touched, the second processing procedure refers to detecting the position input with respect to the second display surface 21a1, specifying processing corresponding to the position input, and executing specified processing. If processing corresponding to the position input is executed, the CPU 100 may display a fifth screen, which is different from the second screen, on the second display surface 21a1.

However, if the position signals are received from the second touch sensor 22 while the elapsed time is within the first threshold since the touch action with respect to the first display surface 11a1, the CPU 100 determines that the touch action has been performed with respect to the second display surface 21a1 (task S103: YES). The CPU 100 determines that the two display surfaces have been simultaneously touched by the user. The CPU 100 obtains the touch position for the second display surface 21a1 based on the position signals from the second touch sensor 22, and stores it in the memory 200.

Next, the CPU 100 determines whether or not a subsequent action to the simultaneous touch action has been performed on the respective display surfaces. Examples of the subsequent action to the simultaneous touch action comprise actions in which the user causes the finger that touched the respective display surfaces to slide. The CPU 100 obtains the current input position by acquiring the current position signals for the respective display surfaces after the touch action is performed on the respective display surfaces (task S106). The CPU 100 reads the position at which the touch action is first performed with respect to the respective display surfaces from the memory 200. The CPU 100 then compares the current input position to the touch position and obtains the position change.

The CPU 100 determines whether or not changes in the input position exceed a second threshold (task S107). The second threshold may be set appropriately. If the second threshold is too small, even if the user happens to move the finger slightly without intending to perform a slide action, it may be mistakenly determined to be a slide action. If the second threshold is too large, the user needs to perform a greater move of the finger, which may result in poor operability. Therefore, the second threshold is set taking into consideration the possibility of misdetection and operability.

If changes in the input position do not exceed the second threshold, the CPU 100 determines that no slide action has been performed (task S107: NO). Until the elapsed time since the touch action to the first display surface 11a1 reaches a third threshold, the CPU 100 determines whether or not there are position changes resulting from the slide action (task S108: NO, task S107). The third threshold may be set appropriately. Until the elapsed time since the simultaneous touch action is detected reaches the third threshold, the CPU 100 may determine whether or not there is a position change, resulting from the slide action.

If there is no position change resulting from the slide action (task S107: NO) and the elapsed time since the touch action on the first display surface 11 al exceeds the third threshold, the CPU 100 determines that the elapsed time has reached the third threshold (task S108: YES). The CPU 100 determines that no slide action is performed and only a simultaneous touch action has been performed. If it is determined that only a simultaneous touch action has been performed, based on the information displayed on the first screen and the information displayed on the second screen, the CPU 100 generates a new third screen. The CPU 100 displays the third screen on the first display surface 11 al and the second display surface 21a1 (task S109). The third screen may also be referred to as a combined screen or a third image. The third screen is displayed on the display surface that is formed by the first display surface 11 al and the second display surface 21a1. The third image comprises information displayed on the first display surface 11a1 and information displayed on the second display surface 21a1. The third image may also comprise information about a predetermined function.

The area in which the third screen is displayed is divided into the first display surface 11a1 and the second display surface 21a1 . The CPU 100 may set the third screen by combining the output image from the first program and the output image from the second program and by comprising the background image to these output images. For example, as shown in FIG. 5(b), the third screen comprises at least some of the compressed images displayed on the first screen in FIG. 5(a) and the raw image of pictures displayed on the second screen in FIG. 5(a).

The third screen is displayed by being divided into the first display surface 11a1 and the second display surface 21a1 . The raw image of a picture a is displayed spanning the first display surface 11a1 and the second display surface 21a1 . If the user moves the position of the compressed images of the pictures a to d by touching them with their finger, the compressed image of the picture a disappears and instead of the picture a, the compressed image of a subsequent picture e is displayed. The frames of two cabinets, namely cabinets 10, 20, are sandwiched between the first display surface 11a1 and the second display surface 21a1. Therefore, the frames are disposed in the new display surface, in which the first display surface 11a1 and the second display surface 21a1 are combined.

However, if the CPU 100 detects that changes in the input position exceed the second threshold, it determines that the slide action has been performed (task S107: YES). After receiving the detection signals from the clock 311, the CPU 100 starts measuring the elapsed time since the previous slide action (task S110) from the beginning.

Next, the CPU 100 determines whether the slide action has been performed with respect to either one of the first display surface 11a1 or the second display surface 21a1 or with respect to both display surfaces. For example, assume that the slide action with respect to the first display surface 11a1 is detected first. In this case, the CPU 100 receives the position signals from the second touch sensor 22 and obtains the current input position on the second display surface 21a1 from the position signals (task S111). The CPU 100 then reads the touch position on the second display surface 21a1 from the memory 200.

The CPU 100 obtains changes in the input position, based on the touch position and the current input position on the second display surface 21a1. If the changes in the input position exceed the second threshold, the CPU 100 determines that the slide action has been performed with respect to the second display surface 21a1 (task S112: YES). Accordingly, the CPU 100 determines that the slide action has been performed with respect to both display surfaces.

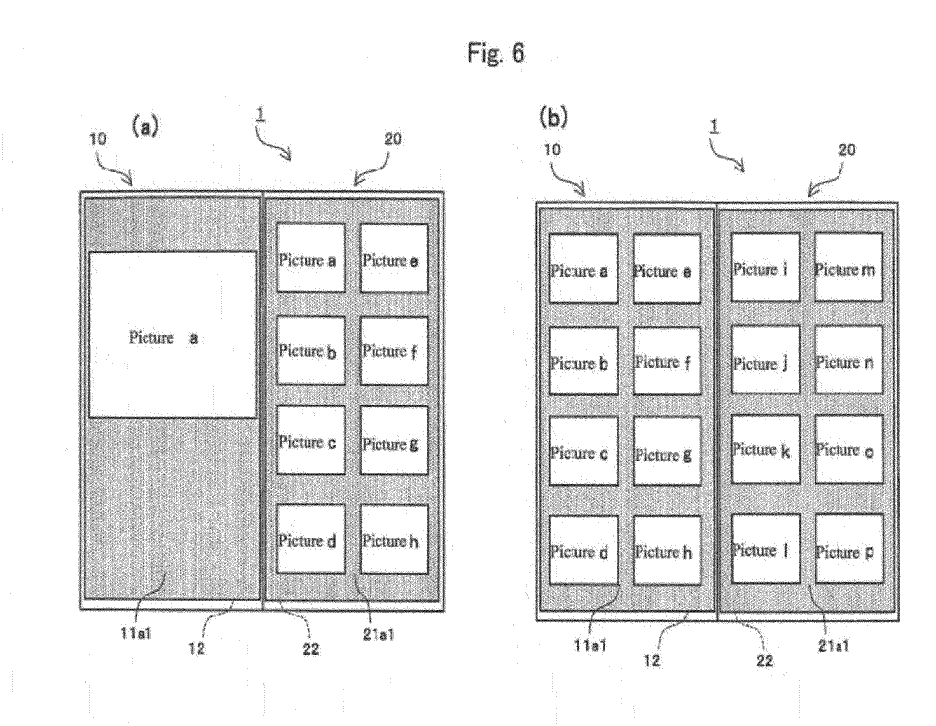

If the CPU 100 determines that the slide action has been performed with respect to both display surfaces, it displays the output image from the first program on the second display surface 21a1 and the output image from the second program on the first display surface 11a1 (task S113). Accordingly, the first screen and the second screen are switched and displayed on the respective display surfaces. For example, as shown in FIG. 5(a), for cases in which the first screen comprising the compressed images of the plurality of pictures is displayed on the first display surface 11a1 and the second screen comprising the raw image of one picture is displayed on the second display surface 21a1, as shown in FIG. 6(a), the CPU 100 displays the second screen comprising the raw image of one picture on the first display surface 11a1 and the first screen comprising the compressed images of the pictures on the second display surface 21a1.

However, if changes in the input position based on the position signals from the second touch sensor 22 are not detected, the CPU 100 determines that no slide action has been performed with respect to the second display surface 21a1 (task S112: NO). However, it may be difficult for the user to slide their finger simultaneously. Therefore, if the slide action is detected with respect to the other display surface while the elapsed time is within the predefined time since the previous slide action, the CPU 100 may determine that the display surfaces were slid simultaneously.

The CPU 100 compares the elapsed time since the previous slide action to a fourth threshold (task S114). If the elapsed time has not reached the fourth threshold (task S114: NO), the CPU 100 obtains the position signals from the second touch sensor 22 (task S111) and determines whether or not the slide action has been performed on the second display surface 21a1 (task S112). For cases in which the elapsed time is within the fourth threshold, if the CPU 100 determines that the slide action has been performed on the second display surface 21a1 , the CPU 100 displays the information displayed on the respective display surfaces by switching (task S113). The fourth threshold is set appropriately so as to be permitted such that the slide action is performed with respect to the respective display surfaces 11a1 , 21a1 , simultaneously.

If time passes and the elapsed time since the slide action with respect to the first display surface 11a1 exceeds the fourth threshold (task S114: YES), the CPU 100 determines that the slide action has been performed with respect to the first display surface 11a1 only.

If the CPU 100 first detects the slide action with respect to the second display surface 21a1, it may detect the slide action with respect to the first display surface 11a1 at task S111, task S112.

Subsequently, the CPU 100 detects on which one of the two display surfaces the slide action has been performed (task S115). At this time, based on the identification information added to the position signals, the CPU 100 identifies the touch sensor in which changes in the input position exceeding the second threshold are present. The CPU 100 then detects the display surface corresponding to the identified touch sensor.

If changes in the input position based on the position signals from the first touch sensor 12 exceed the second threshold, the CPU 100 determines that the slide action has been performed with respect to the first display surface 11a1 (task S115: YES). The CPU 100 displays the image that is output as the first program is executed, on the first display surface 11a1 and the second display surface 21a1. As shown in FIG. 6(b), the CPU 100 executes the first program that displays a list of pictures and displays the compressed images on the first display surface 11a1 and the second display surface 21a1 (task S117). The screens displayed on the first display surface 11a1 and the second display surface 21a1 change from the screens shown in FIG. 5(a) to the screens shown in FIG. 6(b). Accordingly, the CPU 100 can display many compressed images of the pictures all at once, on the enlarged display surface. In FIG. 6(b), the screens output as the second program is executed are not displayed on the respective display surfaces.

However, if changes in the input position based on the position signals from the second touch sensor 22 exceed the second threshold, the CPU 100 determines that the slide action has been performed with respect to the second display surface 21a1 (task S115: NO). The CPU 100 displays the screen that is output as the second program is executed, on the first display surface 11a1 and the second display surface 21a1.

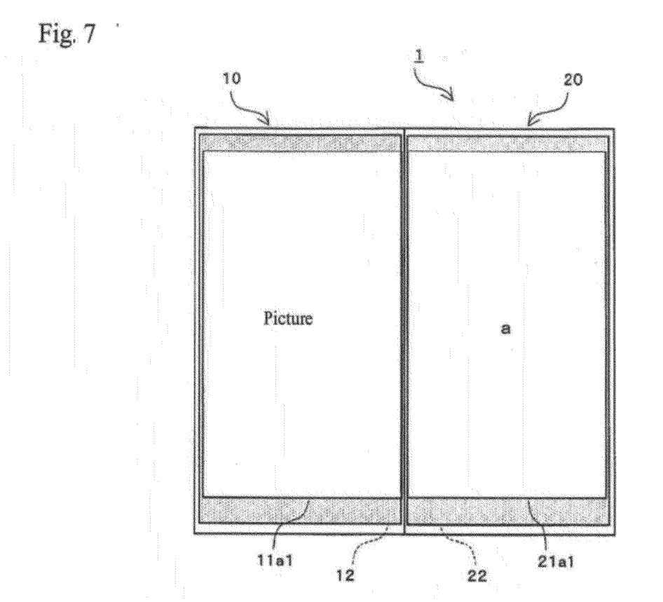

A new third display surface that combines the first display surface 11a1 and the second display surface 21a1 is formed. Since the CPU 100 displays the screens output as the second program is executed on the second display surface 21a1 alone, it changes to the display on the first display surface 11a1 and the second display surface 21a1 (task S116). Accordingly, it can display the image of the picture a even larger. The screens displayed on the first display surface 11a1 and the second display surface 21a1 change from the screens displayed in FIG. 5(a) to the screens displayed in FIG. 7. In FIG. 7, the screens output as the first program is executed may not have to be displayed on the respective display surfaces.

Based on the output from the two touch sensors, the CPU 100 determines the specific combination of the touch, slide, etc. According to the determination results, the CPU 100 controls the screens displayed on the two display surfaces. Accordingly, as the two touch panels are combined, the operability improves compared to conventional mobile phones.

Based on the input with respect to the first display surface 11a1 and the second display surface 21a1, the screens displayed on the two display surfaces 11a1, 21a1 are switched and/or combined. Accordingly, not only is it possible to display the screens individually on the two display surfaces 11a1, 21a1, it is also possible to change the display areas of the screens and enlarge the area for displaying the screens. Therefore, as the display format is diversified, it is possible to respond to a wide range of user needs.

The screens are controlled according to the relationship of the actions by the user with respect to the two display surfaces, such as whether or not the user's finger is touching and/or sliding with respect to the two display surfaces and whether or not the timing of these actions is the same. Therefore, it is not necessary for the user to operate the operation keys 37 to which the function of the screen control is assigned nor is it necessary for the user to operate the screen position, making it convenient. The user can adjust the presence and timing of actions such as the touch action and the slide action in order to operate intuitively.

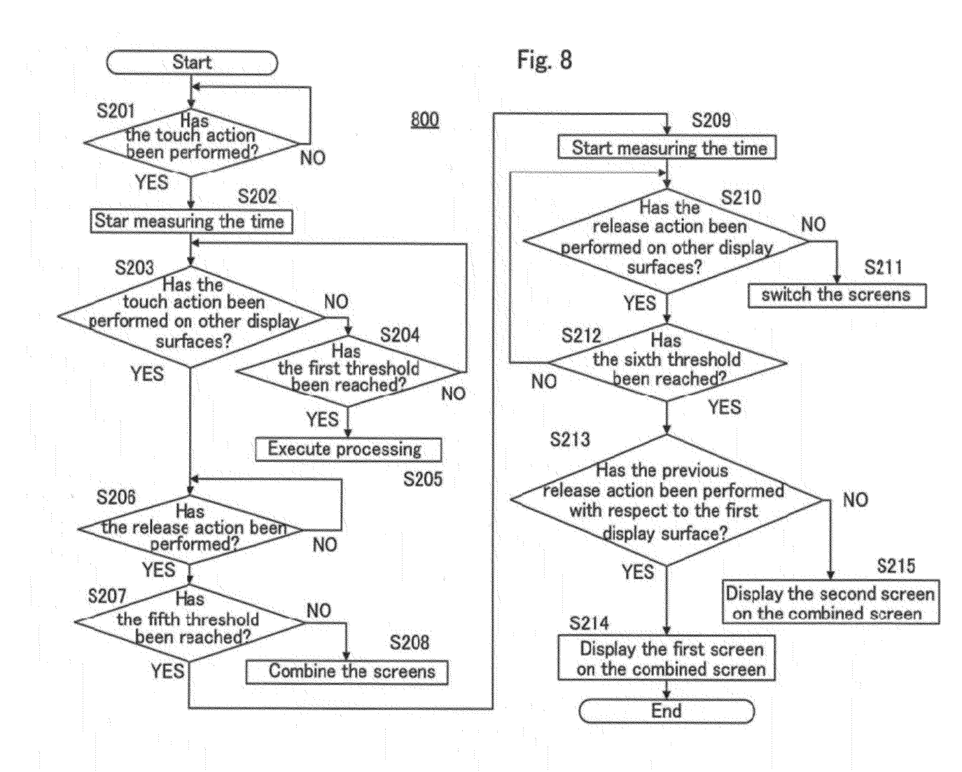

As actions subsequent to the simultaneous touch actions, based on the duration during which the user is touching both the first display surface 11a1 and the second display surface 21a1 or either one of the display surfaces, the mobile phone 1 may control the display of the first display surface 11a1 and the second display surface 21a1. For example, if a long touch action is detected with respect to both the first display surface 11 al and the second display surface 21a1 or either one of the display surfaces after the simultaneous touch action is determined, the CPU 100 may change the display method of image data such as pictures stored previously in the memory 200. The “long touch action” refers to the action in which the user continuously touches both the first display surface 11a1 and the second display surface 21a1 or either one of the display surfaces with a contact member. The method in which the mobile phone 1 controls the display of the first display surface 11a1 and the second display surface 21a1 based on the duration is explained with reference to FIG. 8.

FIG. 8 is an illustration of a flowchart showing a process for controlling display screens of a mobile electronic device according to an embodiment of the disclosure. The various tasks performed in connection with the process 800 may be performed by software, hardware, firmware, a computer-readable medium having computer executable instructions for performing the process method, or any combination thereof. The process 800 may be recorded in a computer-readable medium such as a semiconductor memory, a magnetic disk, an optical disk, and the like, and can be accessed and executed, for example, by a computer CPU such as the control module 100 in which the computer-readable medium is stored.

It should be appreciated that process 800 may include any number of additional or alternative tasks, the tasks shown in FIG. 8 need not be performed in the illustrated order, and process 800 may be incorporated into a more comprehensive procedure or process having additional functionality not described in detail herein. In practical embodiments, portions of the process 800 may be performed by different elements of the systems 300 such as: the CPU 100, the memory 200, the video encoder 301, the audio encoder 302, the key input circuit 303, the communication module 304, the backlight drive circuit 305, the video decoder 306, the audio encoder 307, the battery 309, the power supply module 310, the clock 311, the first display 11, the first touch sensor 12, the second display 21, the second touch sensor 22, etc. Process 400 may have functions, material, and structures that are similar to the embodiments shown in FIGS. 1-3. Therefore common features, functions, and elements may not be redundantly described here.

Process 800 controls the screens to be displayed on the first display surface 11a1 and the second display surface 21a1 . An explanation for task S201 to task S205 in the process 800 is omitted because they are similar to task S101 to task S105 in FIG. 8.

The third processing procedures stored in the memory 200 may be processed according to the specific combination of the input signals of the first touch sensor 12 and the input signals of the second touch sensor 22. This specific combination comprises an aspect in which within a predefined time after either one of the first touch sensor 12 or the second touch sensor 22 detects an input, the other touch sensors 12, 22 detect the input, and subsequently, after another predefined time, the first touch sensor 12 and the second touch sensor 22 detect that there are no more inputs at the same or different timing.

In the state in which the two display surfaces are simultaneously touched, the CPU 100 determines whether or not the touch action with respect to the display surfaces is a long touch action. The CPU 100 observes whether or not the position signals from the first touch sensor 12 and the second touch sensor 22 are input continuously since they are first touched (task S206). When the position signals are being input from the respective touch sensors to the CPU 100, the CPU 100 determines that the user's finger is continuously brought into contact with the display surface.

If the user's finger is released from the display surface, the CPU 100 determines that the position signals are not input from the respective touch sensors and detects that a release action has been performed (task S206: YES). The “release action” refers to the action in which the user releases the contact member that is brought into contact with the display surface from the display surfaces.

The CPU 100 then receives the signals from the clock 311 and obtains the elapsed time from the touch action to the release action. If the elapsed time is within a previously defined fifth threshold, because the time from the previous touch action to the release action is short, the CPU 100 determines that it is not a long touch action (task S207: NO). Accordingly, the CPU 100 forms a new sixth screen that combines the information displayed on the first screen and the information displayed on the second screen, and displays, for example, the sixth threshold as shown in FIG. 5 (b) on the respective display surfaces (task S208). The fifth threshold is set appropriately. The third screen and the sixth screen may be the same or they may be different.

In contrast, if the elapsed time from the previous touch action to the release action exceeds the fifth threshold, the CPU 100 determines it to be a long touch action (task S207: YES). After receiving detection signals from the clock 311, the CPU 100 starts measuring the elapsed time since the previous release action (task S209) from the beginning.

Next, in order to determine whether or not the release action is performed simultaneously, the CPU 100 determines whether or not the position signals are input from the touch sensor, which is different from the touch sensor on which the release action is performed. If the position signals are not input, the CPU 100 determines that the release action has been performed as the user's finger is released from other display surface (task S210: YES). Accordingly, the CPU 100 determines that the release action has been simultaneously performed with respect to both the display surfaces 11a1, 21a1, and for example, as shown in FIG. 5(a), it switches the information on the first screen with the information on the second screen (task S211).

However, if the position signals are input to the CPU 100 from another touch sensor, which is different from the touch sensor to which the release action is previously performed, the CPU 100 determines that no release action has been performed with respect to the other touch sensor (task S210: NO). However, because it is difficult for the user to completely match the timing to release from the respective display surfaces 11a1, 21a1, as long as the release action is performed with respect to the other display surface while the elapsed time is within the predefined time since the previous release action, it may be considered that the release action has been performed simultaneously.

Hence, the CPU 100 determines whether or not the elapsed time since the previous release action has reached the previously defined sixth threshold (task S212). If the elapsed time since the previous release action is shorter than the sixth threshold, the CPU 100 determines that the elapsed time has not exceeded the sixth threshold (task S212: NO). The CPU 100 then determines again whether or not there are position signals from the other touch sensor (task S210). For cases in which the elapsed time has not reached the sixth threshold (task S212: NO), if the CPU 100 detects that the position signals are not input from the other touch sensor and the release action has been performed (task S210: NO), it switches the information on the two screens (task S113). The sixth threshold may be set appropriately such that the release action from the respective display surfaces is permitted to be performed simultaneously.

In contrast, if the elapsed time since the previous release action exceeds the sixth threshold (task S212: YES), the CPU 100 determines that the release action has not been performed simultaneously with respect to the two display surfaces. The CPU 100 determines whether the display surface to which the release action has been performed previously is either one of the first display surface 11a1 or the second display surface 21a1 (task S213). Based on the identification information added to the position signals, the CPU 100 identifies the touch sensor from which the position signals are no longer detected (task S213).

If the position signals are no longer detected from the first touch sensor 12 before the second touch sensor 22, the CPU 100 determines that the release action has been performed with respect to the first display surface 11a1 (task S213: YES). Hence, as shown in FIG. 6(b), the CPU 100 forms the new third display surface, using the first display surface 11a1 and the second display surface 21a1, and displays the image output from the first program on the third display surface (task S214).

However, if the position signals from the second touch sensor 22 are no longer detected first, the CPU 100 determines that the release action has been performed with respect to the second display surface 21a1 (task S213: NO). As shown in FIG. 7, the CPU 100 forms a combined screen and displays images based on the output from the second program on the combined screen (task S215).

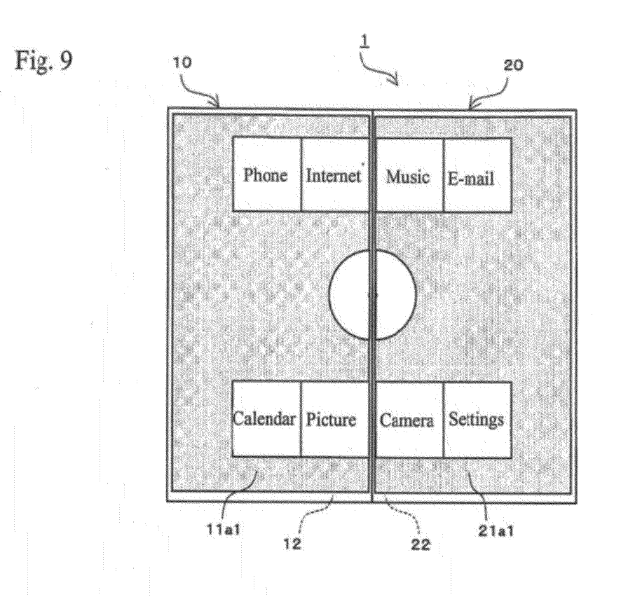

In contrast to FIG. 5(b), the image, which is different from the image displayed on the respective screens, may be displayed on the combined screen before combining the two screens. As shown in FIG. 9, a seventh screen for the operation menu comprising a plurality of icon images indicating the operation is displayed on the first display surface 11 al and the second display surface 21a1 . Functions of the operation allocated to the icon may be previously defined or set arbitrarily by the user. Both the first screen and the second screen or either one of the screens before the operation menu is displayed may be displayed along with the fifth screen that shows the operation menu. In this case, the CPU 100 semi-transparently displays the fifth screen so as to make the first screen and the second screen visible through the semi-transparent fifth screen.

In one embodiment, a screen was generated based on the first screen displayed on the first display surface 11a1 and the second screen displayed on the second display surface 21a1, and the screen was displayed on the first display surface 11a1 and the second display surface 21a1. In contrast to this, according to the predefined operation, the screen generated may be returned to the first screen and the second screen. When returning the screen generated to the first screen and the second screen, the first screen may be displayed on the first display surface 11a1 and the second screen on the second display surface 21a1. The predefined operation comprises the above operations such as the touch action and the operation in which the mobile phone 1 is folded as the two cabinets 10, 20 are superimposed.

In one embodiment, the first program and the second program are the same type of programs that display the images of the picture; however, the program that controls the information to be displayed on the respective screens may be different types of programs. The output information of the program displaying the images may be displayed on one screen among the two screens, and output information of the program displaying the movies may be displayed on the other screen. The output information of the program displaying the address book may be displayed on one screen among the two screens, and the output information of the program displaying the web screen may be displayed on the other screen.

In one embodiment, a sliding mobile phone 1 was used; however, a mobile phone 1 that is not of the sliding type, such as a folding type, may also be used. In this case, the mobile phone 1 comprises the state in which the two display surfaces are not visible from the outside as the two display surfaces overlap facing each other; and the state in which the two display surfaces appear on the outside as the two display surfaces are placed side by side to each other.

In the above embodiment, as actions subsequent to the touch actions, the slide action and/or release action were detected; however, other actions can also be detected. For example, by performing flick actions simultaneously with respect to the display surfaces 11a1, 21a1, information displayed on the respective display surfaces 11a1, 21a1 can be changed and/or the operation menu screens can also be displayed. By performing other actions simultaneously with respect to the respective display surfaces 11a1, 21a1, information displayed on the respective display surfaces 11a1, 21a1 can also be changed.

The “flick action” refers to the action in which the contact member is moved for more than a predefined distance (for example, 50 pixels) within the predefined time (for example, 50 ms) while keeping the contact member in contact with the respective display surfaces 11a1, 21a1, that is, the flick action refers to the action in which the contact member is quickly released from the respective display surfaces 11a1, 21a1, as if flicking. The long-touch action, slide action, and flick action are actions in which the contact member is brought into contact with the respective display surfaces 11a1, 21a1, and they can also be referred to as touch actions.

In this document, the terms “computer program product”, “computer-readable medium”, and the like may be used generally to refer to media such as, for example, memory, storage devices, or storage unit. These and other forms of computer-readable media may be involved in storing one or more instructions for use by the control module 100 to cause the control module 100 to perform specified operations. Such instructions, generally referred to as “computer program code” or “program code” (which may be grouped in the form of computer programs or other groupings), when executed, enable a method of using a system.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device comprising:
a first display module;
a second display module;
a first detector located on the first display module operable to detect a first input;
a second detector located on the second display module operable to detect a second input; and
a control module operable to control a first display screen on the first display module and a second display screen on the second display module when the first detector detects the first input and the second detector detects the second input.

2. The mobile electronic device according to claim 1, wherein the control module is further operable to display a third image on the first display module and the second display module, and a first image is displayed on the first display module and a second image is displayed on the second display module.

3. The mobile electronic device according to claim 2, wherein the third image comprises information displayed on the first display screen and information displayed on the second display screen.

4. The mobile electronic device according to claim 2, wherein the control module is further operable to display the third image on the first display screen and on the second display such that the third image is overlaid on the first image and the second image.

5. The mobile electronic device according to claim 4, wherein the third image comprises information about a predetermined function.

6. The mobile electronic device according to claim 2, wherein the control module is further operable to display only the third image on the first display and on the second display from among the first image, the second image, and the third image.

7. The mobile electronic device according to claim 2, wherein the control module is further operable to display the first image on the second display screen module and display the second image on the first display screen, if the first image is displayed on the first display screen and the second image is displayed on the second display.

8. The mobile electronic device according to claim 2, wherein the control module is further operable to display a fourth image, which comprises information about the first image, on the first display screen and on the second display if the first detector detects a third input after the second input is detected while the first image is displayed on the first display screen and the second image is displayed on the second display screen.

9. The mobile electronic device according to claim 8, wherein:
the first input comprises the first display screen touched by a user;
the second input comprises the second display screen touched by the user; and
the third input comprises change of position of the first display screen touched by the user.

10. The mobile electronic device according to claim 8, wherein the fourth image does not comprise information about the second image.

11. The mobile electronic device according to claim 2, wherein:
the first input comprises a first display screen touched by a user; and
the second input comprises a second display screen touched by the user.

12. The mobile electronic device according to claim 2, wherein the control module is further operable to display a first part of the third image on the first display screen and display a second part of the third image on the second display screen.

13. The mobile electronic device according to claim 1, wherein:
the first input comprises a first position change indicating the first display is touched by a user; and
the second input comprises a second position change indicating the second display is touched by the user.

14. A method for operating a mobile electronic device, the method comprising:
detecting a first touch input on a first display screen;
detecting a second touch input on a second display screen, if a first time threshold is not reached; and
combining the first display screen and the second display screen to operate as a single display screen, if a second time threshold is reached after the first touch input.

15. The method according to claim 14, further comprising switching a first content of the first display screen to the second display screen and a second content of the second display screen to the first display screen, if the second time threshold is not reached after the first touch input, and a first slid operation is performed on the first display screen and a second slid operation is performed on the second display screen.

16. The method according to claim 14, further comprising combining the first display screen and the second display screen to operate as a single display screen, and displaying a first content of the first display screen on the single display screen, if the second time threshold is not reached after the first touch input, a first slid operation is performed on the first display screen, and a third time threshold is reached after the second touch input.

17. A computer readable storage medium comprising computer-executable instructions for performing a method for operating a portable electronic device, the method executed by the computer-executable instructions comprising:
detecting a first touch input on a first display screen;
detecting a second touch input on a second display screen, if a first time threshold is not reached; and
combining the first display screen and the second display screen to operate as a single display screen, if a second time threshold is reached after the first touch input.

18. The computer readable storage medium according to claim 17, the method executed by the computer-executable instructions further comprising switching a first content of the first display screen to the second display screen and a second content of the second display screen to the first display screen, if the second time threshold is not reached after the first touch input, and a first slid operation is performed on the first display screen and a second slid operation is performed on the second display screen.

19. The computer readable storage medium according to claim 17, the method executed by the computer-executable instructions further comprising combining the first display screen and the second display screen to operate as a single display screen, and displaying a first content of the first display screen on the single display screen, if the second time threshold is not reached after the first touch input, a first slid operation is performed on the first display screen, and a third time threshold is reached after the second touch input.
